(19) United States
(12) Patent Application Publication
(10) Pub. No.: US 2003/0020942 A1
(43) Pub. Date: Jan. 30, 2003

(54) Computer-assisted printer error diagnosis

(76) Inventor: Marcos Teres, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/918,688

(22) Filed: Jul. 30, 2001

(51) Int. Cl. B41F 1/00; G06F 15/00

(52) U.S. Cl. 358/1.14

(57) ABSTRACT

A method and system for diagnosing a malfunction in a printer system using a processor, the method including communicating a description of one or more symptoms of the printer system malfunction to the processor, correlating the symptoms with known printer system malfunctions by comparing the symptoms with a database in the memory of known printer malfunctions, identifying a most appropriate malfunction that would produce the described symptoms, and reporting the most appropriate malfunction.

### FIELD OF THE INVENTION

The present invention relates generally to printers and more particularly, to a system and method of using a computer to aid in diagnosing a printer malfunction.

### BACKGROUND OF THE INVENTION

As computer printers become more affordable, increasing numbers of homes and workplaces are using personal computers and printers for routine document preparation. At the same time, highly sophisticated printers are being developed that include input and output devices such as automated paper trays, multi-bin sorters, output stackers, and output staplers. The mechanical and electronic complexity of modem printers is such that the typical user is unable to service the printer themselves, and must contact a qualified service technician whenever the printer malfunctions.

In order to make a service call as efficient as possible, the service technician typically attempts to identify the nature of the printer malfunction before making the service call, generally by soliciting the user for a description of the malfunction. Unfortunately, the person contacting the service technician may not be the actual user of the printer, and may be unfamiliar with the problem actually being experienced. Even where the service technician can speak directly to the printer user, that user is typically not an expert in printer operation and servicing, and often provides either incomplete or even misleading information to the service technician.

Based on incomplete information, the service technician is likely to make a preliminary diagnosis of the printer problem that is incorrect. The misdiagnosis is not likely to be corrected until the service technician personally examines the malfunctioning printer and is able to make a more accurate diagnosis. Unfortunately, any previously selected replacement parts brought along on the service call based on an earlier misdiagnosis may not be needed, and an additional service call may be subsequently required in order to give the service technician an opportunity to retrieve the replacement parts that may be actually required to repair the actual malfunction. Typically, multiple service calls are required to effect repairs of the printer, adding considerably to the cost of the repair itself.

In an attempt to make service calls more economical, several strategies have been employed to make the initial communication of the printer problem to the service technician more accurate. For example, printers have been developed that detect errors in operation and provide error messages on a small display. While such error displays are useful to a service technician in the field, it has been found that printer users sometimes ignore the error display, or fail to convey the error message to the service technician. Furthermore, the printer error display is typically limited in size, and can display only minimal error information to the user. An additional drawback lies in the fact that the displayed error message may not identify the root cause of a given printer malfunction, but may reflect a consequence of the original malfunction.

While communicating printer errors to the service technician may help in formulating an initial malfunction diagnosis, this communication places a great deal of responsibility on the person who contacts the service technician, especially where the person who contacts the service technician may or not be the actual user of the malfunctioning printer, and may be only mildly interested in helping the service technician make the best initial diagnosis possible.

What is needed is a method of providing an initial diagnosis of the malfunction exhibited by the printer system that does not require an experienced service technician or a highly skilled printer user. More accurate assessments of printer malfunctions thus may result in fewer service calls, decreased overall workload, and increased efficiency. Ideally, the initial diagnosis may be sent directly to the service technician or printer service facility.

### SUMMARY OF THE INVENTION

The invention provides a method for diagnosing a malfunction in a printer system using a processor wherein the method involves communicating a description of one or more symptoms of the printer system malfunction to the processor, analyzing the symptoms using the processor by comparing the symptoms with a database in the memory that correlates symptoms with known printer system malfunctions, identifying a most appropriate malfunction that would produce the described symptoms, and reporting the most appropriate malfunction The invention also concerns a system for diagnosing a malfunction in a printer system, where the system includes a database correlating symptoms of printer system malfunctions with known printer system malfunctions, and a processor configured to collect a description of one or more symptoms of the printer system malfunctions, analyze the symptoms by comparing them to the database, identify a most appropriate malfunction that would produce the described symptoms, and report the most appropriate malfunction.

### BRIEF DESCRIPTION OF THE DRAWINGS

FIG. 1 is a schematic illustration of a computer system for use in diagnosing a printer malfunction in accordance with the present invention.

FIG. 2 is a schematic illustration showing suitable processor inputs and outputs useful in carrying out the present invention.

FIG. 3 is a flow diagram demonstrating a method for diagnosing a printer malfunction in accordance with the present invention.

FIG. 4 is a schematic illustration showing the communication of a printer error log from the printer system to the processor, and the processor generating a report.

FIG. 5 is an exemplary dialog box according to the present invention requesting an authorization from the printer system user to print a test page.

FIG. 6 is an exemplary dialog box according to the present invention requesting input from the printer system user on a test print operation.

FIG. 7 is a schematic illustration showing the transmission of a report to a display, to an internet connection, or directly to a printer service facility.

### DETAILED DESCRIPTION OF THE INVENTION

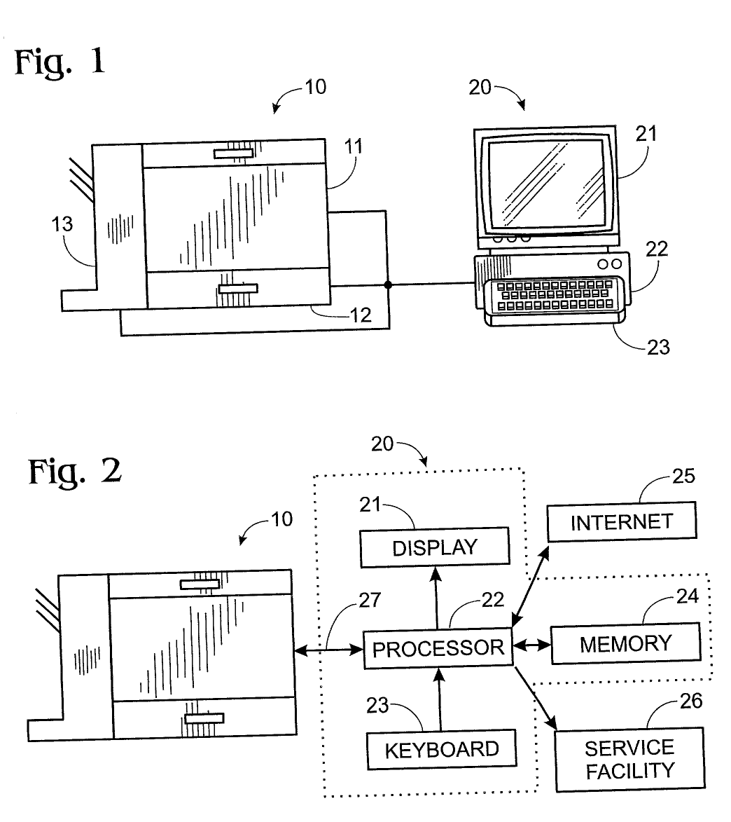

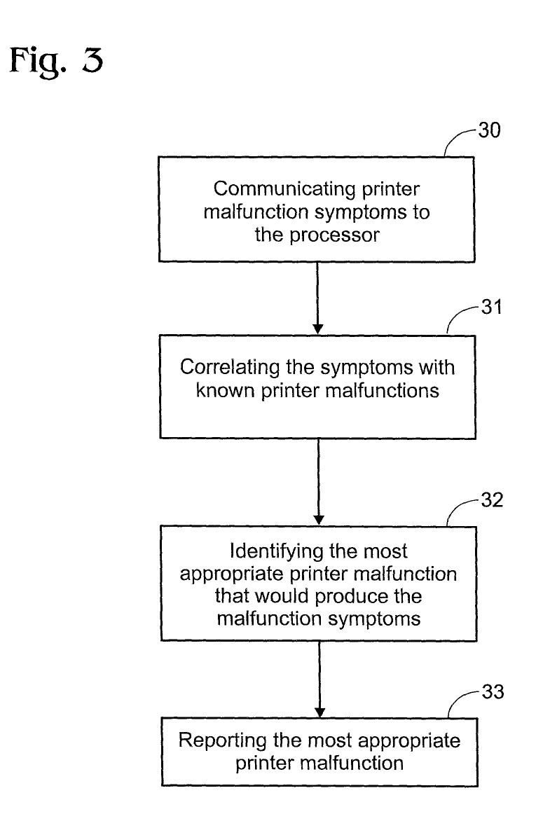

A computer system for implementing the method for diagnosing a printer malfunction is indicated generally at 20 in FIG. 1. The computer system typically includes a processor 22, an input 23, and an output 21. The processor of FIG. 1 employs a keyboard input device 23 and a display output device 21. In addition, computer system 20 is in communication with a printer system 10 that includes a printer 11, and optionally, a printer input device 12, and/or a printer output device 13. As shown in FIG. 2, the computer system processor 22 is in direct or indirect communication with the printer system 10 via the connection 27. Connection 27 is optionally a direct communication cable between the printer system and the computer system. Alternatively, connection 27 is an Internet connection. The processor 22 is also in communication with a memory 24, and may further be in communication with a remote serve via an Internet connection 25, or with a printer service facility 26.

A computer-assisted method for diagnosing a malfunction in the printer system is set forth in the flow diagram of FIG. 3. As shown at 30 in FIG. 3, the method includes the steps of communicating a description of one or more symptoms of the printer system malfunction to the processor. As shown at 31, the processor analyzes the symptoms using the processor, by comparing those symptoms with a database stored in the memory. The database correlates potential printer malfunction symptoms with known printer system malfunctions. By comparing the symptoms that have been communicated to it with the database, the processor identifies a most appropriate malfunction that would produce the described symptoms, as shown at 32 of FIG. 3. Once a most appropriate malfunction has been identified, the processor reports the most appropriate malfunction via an output, as shown at 33.

The method of the invention is typically used when a printer system user believes that a printer system is malfunctioning. The malfunction is typically indicated by one or more malfunction symptoms, such as error messages, either on the printer system itself, or displayed by the associated computer system. Alternatively, the symptoms may be physical symptoms, such as frequent jamming, unusual noises during print operations, a deterioration in print quality, or any other printing difficulty.

Upon observing one or more malfunction symptoms, the printer system user typically executes a software application using the processor for the purposes of assisting the user in diagnosing the printer malfunction. Although the computer system of FIG. 1 is depicted as a personal computer, a skilled artisan will immediately appreciate that the processor used to execute the software of the invention is not limited to the processor of a personal computer. The processor may alternatively take the form of a mainframe computer, or server, or any other processing device, whether proximate or remote. Although the processor is preferably directly or indirectly connected to the malfunctioning printer system, the processor may be isolated from the printer system. In one particular embodiment, the processor is a remote server and is accessible by the printer system user via a communications link such as Internet connection 25.

The printer system user communicates a description of one or more symptoms of the printer system malfunction to the processor that is running the software application. In one embodiment, the printer system user enters the descriptions directly via a processor input, such as by selecting items from a display list, by highlighting items on a pulldown menu, or by typing keywords into the appropriate text field. Alternatively, the software application directs the processor to query the associated printer system, and receives a description of one or more symptoms of the printer system malfunction from the printer system itself.

Printers have been developed that maintain an “error log” of the most recent errors detected by the printer itself, including errors from printer output devices. Unfortunately, the printer system user is typically unable to extract useful information from the error log as they don't have the specialized training of a printer service technician. The text of the saved errors also may be confusing to an inexperienced user, and it is often necessary to consider more than one entry in the error log in order to identify the nature of the particular printer problem.

As an illustrative example, consider a printer error log that includes the entries below:

13.22.04 Jam in Exit 1

13.33.05 Jam in Exit 2

66.22.08 Hardware malfunction in output device

13.11.01 Jam in Transfer Unit

If the printer system user tells a service technician that the most recent error was a jam (13.22.04), the technician may form an initial diagnosis that the head assembly in the output device should be replaced. If the technician had been made aware of the recent 66.22.08 error as well, the technician would have been alerted to the possibility of a malfunction with the printer flipper unit that, in turn, typically also creates multiple jams in the downstream paper path.

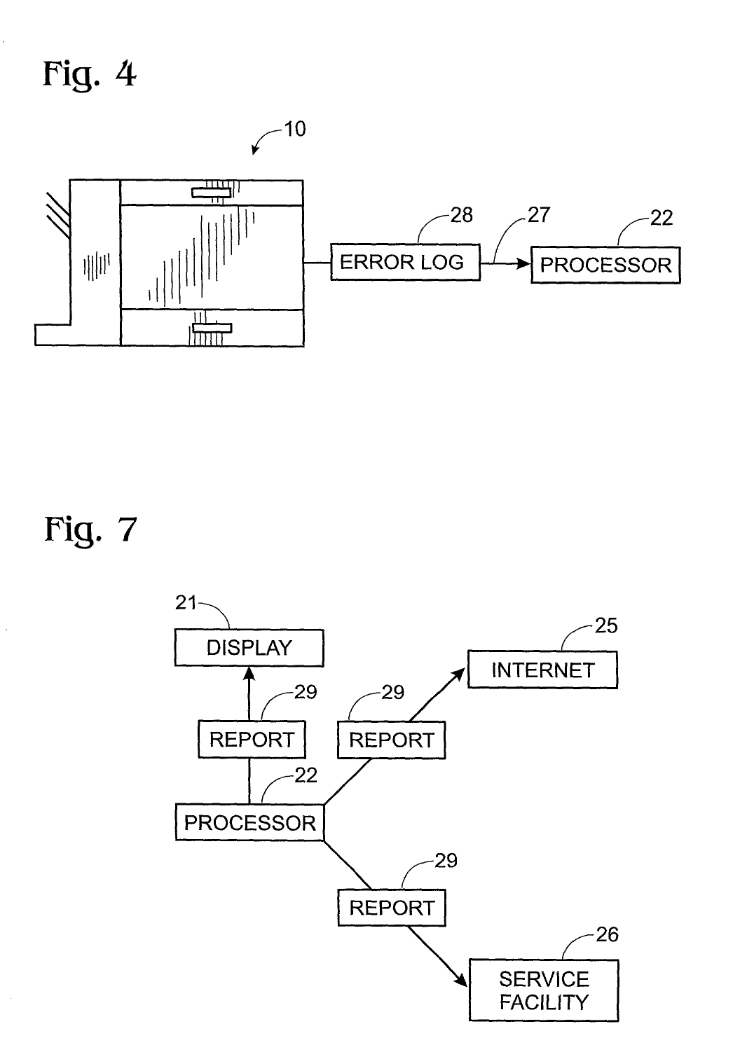

Preferably, in response to the query from the processor, the error log 28 containing the symptoms of the printer system malfunction are communicated to the processor, as depicted in FIG. 4. Where the printer system records an error log, it is typically an error log for the printer itself, but in another aspect of the invention the error log includes error entries for one or more printer input devices 12 or printer output devices 13. Suitable printer input devices include, for example, paper trays. Suitable output devices include, for example, output stackers, output staplers, or multi-bin mailbox sorters. Each input or output device optionally records device errors in the printer system error log for subsequent communication to the processor.

Once the printer system user has communicated the symptoms of the printer system malfunction to the processor, the processor analyzes the symptoms by comparing the symptoms with a database stored in memory. The database contains statistical information correlating known printer malfunctions and symptoms that have been observed to result from those malfunctions in appropriate printers. The database include malfunction data for a variety of printer types. Alternatively, the database may be printer make and/or model specific, and include only specific malfunction data for the printer system under consideration. Communicating the malfunction symptom description to the processor results in the processor utilizing the database to determine the most appropriate malfunction that would result in the observed symptoms.

In a simple embodiment of the invention, the database contains one-to-one correlations between symptoms and malfunctions. That is, input of a particular malfunction symptom results in the processor identifying every possible malfunction that could result, along with a statistical likelihood that a given malfunction was responsible for the symptom. Alternatively, the input of more than one symptom generates multiple lists of potential malfunctions responsible for each distinct symptom. Furthermore, the processor may be configured to analyze the list of potential malfunctions for each symptom, assigning a weighted importance to each malfunction according to its statistical ranking and probability. In this instance, malfunctions that are potentially responsible for more than one of the observed symptoms are given greater weight. The resulting list of possible malfunctions thus may be weighted toward those that are most likely to be responsible for the observed symptoms.

In a further refinement of the invention, the processor analyzes the error log pattern of a printer system, and compares it to a database containing error log patterns correlated with known malfunctions. The error log patterns include not only the particular errors recorded, but the type of errors recorded, including the sequence in which they were recorded. The processor then selects a malfunction that would yield a theoretical error log pattern that most closely matches that recorded in the printer system error log.

At a point before, during, or after the communication of the symptoms of the printer system malfunction to the processor, the processor may request additional input from the printer system user. For example, where analysis of the error log indicates a high probability that a specific malfunction has occurred, the processor may request, via a processor output, that the printer system user complete or initiate a particular print operation, or attempt a particular print command, in hopes of verifying a malfunction diagnosis. Additional input from the printer system user could consist of selecting from a list of possible responses, or simply answering a yes or no answer to a query from the processor.

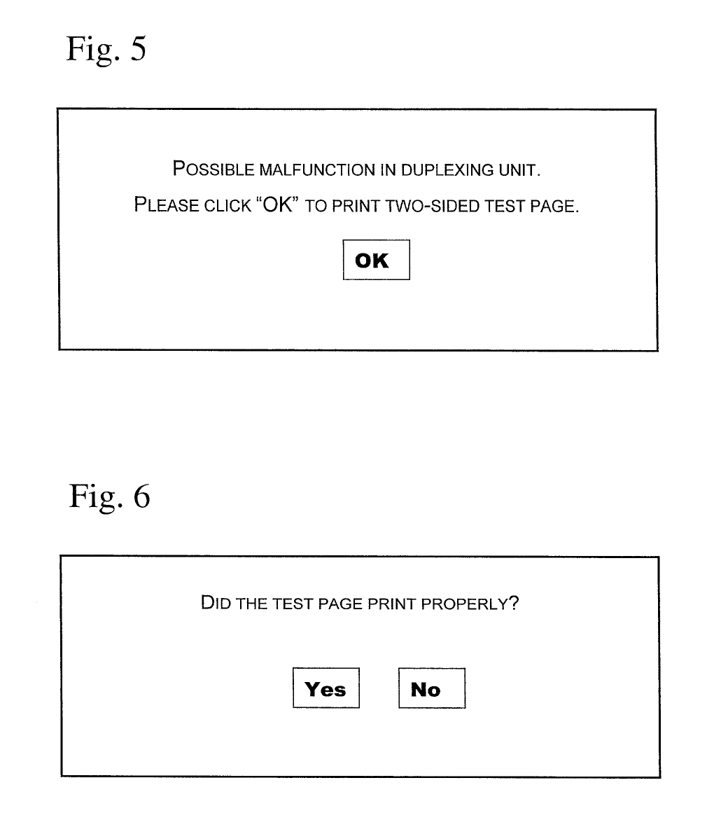

In one exemplary illustration, during the process of analyzing the malfunction symptoms using the database, the processor may determine that there is a strong probability that the printer system malfunction has occurred in the duplexing unit. The processor may then utilize a processor output (e.g. monitor) to display a dialog such as shown in FIG. 5. Upon selection of “OK” by the printer system user, the processor may attempt to print a two-sided test page that is required to utilize the duplexing unit in a way that would confirm whether or not the suspected malfunction was present in the duplexing unit. After sending the document to the printer system, the processor may display a follow-up dialog such as the one shown in FIG. 5. The response of the printer system user to the processor query would then be used by the processor to evaluate whether the duplexing unit was suffering from the suspected malfunction or not. It should be understood by those of skill in the art that a variety of useful print procedures could be envisioned that could be communicated to the printer system user in a similar fashion, to evaluate other potential malfunctions.

After the processor completes the analysis of the malfunction descriptions, the processor identifies a most appropriate malfunction. The most appropriate malfunction is the printer system malfunction that is determined to be the most likely to produce the symptoms that have been communicated to the processor. That is, the most appropriate malfunction is the one that is most likely to be the one afflicting the printer system, considering the nature of the symptoms communicated to the processor, and the nature of the database used.

Once the processor has determined the most appropriate malfunction, that malfunction is reported via generation of a report 29, as shown in FIG. 7. The step of reporting includes a variety of output methods, including but not limited to displaying the report on a monitor, printing a report on an associated printer or printer system, or electronically transmitting a report.

Where the report is electronically transmitted, it is optionally incorporated in an electronic mail message, transmitted as a text document, or in any other suitable electronic format. This electronic transmission optionally utilizes a dial-up connection, or alternatively may be sent via an Internet connection.

The report itself may be delivered to the printer system user, so that the printer system user may communicate the recommendation of the software to a service technician or service facility. Alternatively, the processor generates a report that is sent directly to an appropriate printer service facility, or service technician. The report may even include a recommendation for a particular service procedure.

The particular service procedure recommended by the processor depends upon the nature of the most appropriate malfunction identified by the processor, and may include without limitation, cleaning of selected mechanisms or portions of the printer system, refilling selected consumables in the printer system, such as toner or ink, or servicing or replacing one or more mechanical parts of the printer system.

Although the instant method of diagnosing printer malfunction is typically useful for electrophotographic printers, particularly xerographic printers, it is applicable to the diagnosis of a variety of printer systems, independent of the particular mechanism used for the application of colorant or ink, such as inkjet printers or offset printers. The particular selection of printer system, processor, processor inputs, processor outputs, or database are a matter of choice for the skilled artisan. Accordingly, the present invention is intended to embrace all such alternatives, modifications and variances which fall within the scope of the appended claims.

I claim:

1. A computer-implemented method for diagnosing a malfunction in a printer system using a computer system comprising a processor, the method comprising the steps of:
communicating a description of one or more symptoms of the printer system malfunction to the processor;
correlating the one or more symptoms with known printer system malfunctions;
identifying a most appropriate malfunction that would produce the described symptoms; and
reporting the most appropriate malfunction.

2. The method of claim 1, where the description of the one or more symptoms includes an error log recorded by the printer system.

3. The method of claim 2, where the printer system includes a printer input device, and the error log includes input device errors.

4. The method of claim 3, where the printer system includes a printer output device, and the error log includes output device errors.

5. The method of claim 1 , where the description of one or more symptoms of the printer system malfunction is received from the printer system.

6. The method of claim 1, where the description of one or more symptoms of the printer system malfunction is received from the printer system operator.

7. The method of claim 1, where the step of communicating includes sending a query from the processor to the printer system and receiving descriptions of one or more symptoms of the printer system malfunction from the printer system.

8. The method of claim 1, where the step of reporting includes electronically transmitting a report.

9. The method of claim 8, where the report is electronically transmitted via a communications connection with a printer service facility.

10. The method of claim 9, where the report includes a service procedure recommendation.

11. The method of claim 10, where the service procedure is a part replacement.

12. The method of claim 1, where the processor is accessible via an Internet connection.

13. A system for diagnosing a malfunction in a printer system, comprising:
a database correlating symptoms of printer system malfunctions with known printer system malfunctions; and
a processor configured to collect a description of one or more symptoms of a present printer system malfunction to compare the one or more symptoms of a present printer system malfunction to the database correlations, to identify a most appropriate malfunction that would produce the described symptoms, and to report the most appropriate malfunction.

14. The system of claim 13, where the processor is directly or indirectly linked to the printer system.

15. The system of claim 14, where the printer system is configured to record an error log, and where collection of the description of one or symptoms of a present printer system malfunction includes downloading the error log from the printer system.

16. The system of claim 15, where comparing the one or more symptoms of a present printer system malfunction to the database correlations includes comparing the error log to the database correlations.

17. The system of claim 13, where reporting the most appropriate malfunction includes electronically transmitting a report.

18. The system of claim 13, where reporting the most appropriate malfunction includes a service procedure recommendation.

19. A computer-implemented method of enabling the user of a printer system to diagnose a malfunction of the printer system using a processor, the method comprising the steps of:
communicating a description of one or more symptoms of the malfunction to the processor;
comparing the described symptoms to a database correlating symptoms with known printer system malfunctions;
identifying the malfunction most likely to produce the described symptoms; and
reporting the most likely malfunction to the user.

20. The computer-implemented method of claim 19, where the processor is directly or indirectly linked to the printer system, and the description of one or more symptoms of the malfunction is a printer system error log.
